(19) United States
(12) Patent Application Publication
(10) Pub. No.: US 2015/0186827 A1
(43) Pub. Date: Jul. 2, 2015

(54) Data-driven targeting of energy programs using time-series data

(71) Applicant: The Board of Trustees of the Leland Stanford Junior University, Palo Alto, CA (US)

(72) Inventors: Jungsuk Kwac, Stanford, CA (US); Ram Rajagopal, Palo Alto, CA (US)

(21) Appl. No.: 14/567,648

(22) Filed: Dec. 11, 2014

Related U.S. Application Data
(60) Provisional application No. 61/914,703, filed on Dec. 11, 2013.
(60) Provisional application No. 61/914,681, filed on Dec. 11, 2013.

(51) Int. Cl. G06Q 10/06; G06Q 50/06; G06Q 30/02

(52) U.S. Cl. CPC G06Q 10/06315; G06Q 30/0202; G06Q 50/06

(57) ABSTRACT

A method for enrolling utility customers in utility demand response or energy efficiency programs based on time-series consumption data includes collecting from smart meter sensors time-series utility consumption data from individual utility customers, extracting features from the consumption data, generating a probabilistic response model for each customer representing a relationship between the extracted features and customer program performance by estimating parameters of a response distribution, solving an optimization problem for each customer using the estimated response distribution to achieve a targeting objective, and enrolling selected customers in programs based on the solution to the optimization problem.

### CROSS-REFERENCE TO RELATED APPLICATIONS

This application claims priority from U.S. Provisional Patent Application 61/914,681 filed Dec. 11, 2013 and from U.S. Provisional Patent Application 61/914,703 filed Dec. 11, 2013, both of which are incorporated herein by reference.

### STATEMENT OF GOVERNMENT SPONSORED SUPPORT

This invention was made with Government support under grant (or contract) no. DE-AR0000018 awarded by the Department of Energy. The Government has certain rights in the invention.

### FIELD OF THE INVENTION

The present invention relates generally to systems and methods for analyzing and modifying utility customer energy consumption patterns.

### BACKGROUND OF THE INVENTION

The drive towards more sustainable power supply systems has enabled significant growth of renewable generation. This in turn has pushed the rollout of demand response (DR) programs to address a larger population of consumers. Utilities are interested in enrolling small and medium sized customers that can provide demand curtailment during periods of shortfall in renewable production.

It then becomes important to be able to target the right customers among the large population, since each enrollment has a cost. Moreover, the power curtailment potential across customers varies significantly. Currently, however, most demand response targeting relies on segmentation of customers based on their monthly billing data or surveys.

The goal of a DR program is to elicit flexibility from loads by reducing or shifting consumption in response to external signals such as prices or curtailment indicators. Typically a program is designed to extract a targeted level of energy or power from all the participating loads. The program operation yield is the ratio between the actually extracted energy from the participants and the target level. Current program yields are low, in the range of 10% to 30%. Thus, there exists a need for improved methods for targeting utility customers for program enrollment.

### SUMMARY OF THE INVENTION

Existing approaches to targeting rely on demographic variables to segment consumers and target them. They also do not account for system constraints. The approach of embodiments of the present invention avoids this problem by incorporating data-driven response models for this purpose and an optimization formulation that can account for costs and network system constraints.

In one aspect, the invention provides a methodology that utilizes utility resource consumption (electricity, gas or water) data from individual consumers to optimize the targeting and operation of demand management programs and improve the behavioral response of consumers. The methodology may include, as appropriate, (1) data-driven functional and behavioral response models and/or (2) targeting algorithm that can account for target goals, recruitment costs, physical system constraints and various uncertainties in these quantities. In the present context, targeting means selecting customers for enrollment in a program in offline manner, or including customers in real-time in program operations. In the latter, the response models below are estimated for each round. In the present context, programs are utility resource consumption management programs, such as demand management programs.

A significant feature of embodiments of the invention is the full data-driven approach, including an optimization algorithm that is aware of uncertainties, all of these applied to energy consumption data. Embodiments of the current invention significantly provide targeting recruitment in utility programs (demand response, energy efficiency); increasing consumer behavior change response to energy data. Additional aspects of embodiments of this invention may be refined by approaching different programs and performance goals.

There are variants of the approach: the targeting can rely on measured response models, or targeting can occur progressively, where after a certain number of consumers is targeted, their performance is measured and the response model is updated.

In one aspect, the invention provides a method implemented by a computer for enrolling utility customers in utility demand response or energy efficiency programs based on time-series consumption data. The method includes collecting from smart meter sensors time-series utility consumption data from individual utility customers, extracting by the computer features from the consumption data, generating a probabilistic response model for each customer representing a relationship between the extracted features and customer program performance by estimating parameters of a response distribution, solving an optimization problem for each customer using the estimated response distribution to achieve a targeting objective, and enrolling selected customers in programs based on the solution to the optimization problem.

In some embodiments, solving the optimization problem is performed periodically. The optimization problem may include a reliability constraint that captures behavioral compliance to a demand response signal, wherein the behavioral compliance is represented by a compliance response model dependent upon consumer characteristics, local environmental characteristics, and time of day. The method may additionally include selecting a probabilistic response (targeting) model from among multiple probabilistic response (targeting) models. It may also include communicating to the selected customers the selected programs.

### BRIEF DESCRIPTION OF THE DRAWINGS

FIG. 1 is a schematic diagram illustrating the conceptual flow of data-driven targeting according to an embodiment of the invention.

FIG. 2 is a schematic diagram illustrating an overall flow of a customer targeting process according to an embodiment of the invention.

FIG. 3 illustrates additional processing techniques for customer targeting according to an embodiment of the invention.

FIG. 4 outlines the formulation of a stochastic knapsack problem to be solved for selecting a small number of proper customers from a large population, according to an embodiment of the invention.

FIG. 5 illustrates the brief idea to find the optimal solution of the stochastic knapsack problem (SKP), according to an embodiment of the invention.

FIG. 6 shows an example of customer selection order in a simple greedy algorithm solving the SKP, according to an embodiment of the invention.

FIGS. 7A-B demonstrate two algorithms to solve the SKP, according to an embodiment of the invention.

FIG. 8 is a schematic overview of a system implementing a method for data-driven customer targeting according to an embodiment of the invention.

FIG. 9 is an overview of the main steps of a method for data-driven customer targeting according to an embodiment of the invention.

### DETAILED DESCRIPTION

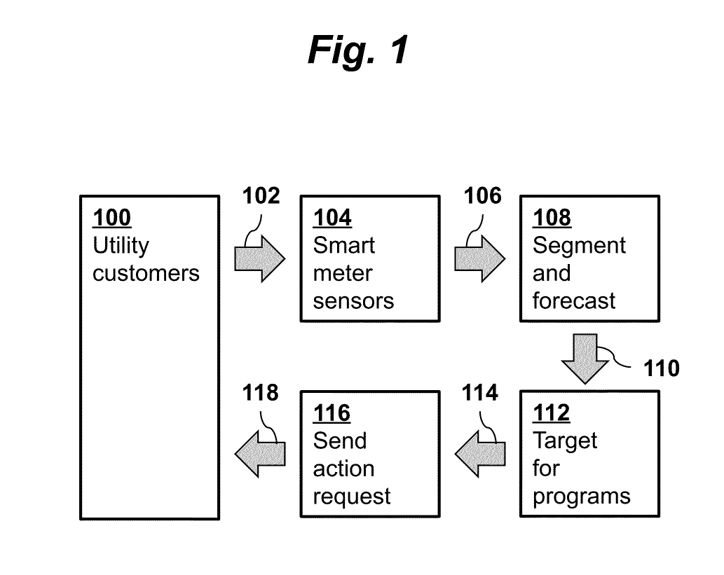

FIG. 1 is a schematic diagram illustrating the conceptual flow of data-driven targeting according to an embodiment of the invention. Utility customers 100 make resource use decisions which result in utility resource consumption 102 sensed by smart meter sensors 104 installed at the customer premises. The smart meter sensors 104 generate time-sequence consumption data 106 that is then centrally processed to learn about the customers, which includes segmenting the customers and forecasting consumption 108, the results of which are provided to be used in targeting customers for programs 112. Targeting selections 114 are then processed 116 to send an action request to selected customers 100 in order to enroll them into the selected programs. As will be described in more detail below, targeting 112 preferably includes extracting features from the consumption data and generating a probabilistic response model for each customer representing a relationship between the extracted features and customer program performance. Targeting is performed by solving an optimization problem for each customer using the estimated response distribution to achieve a targeting objective.

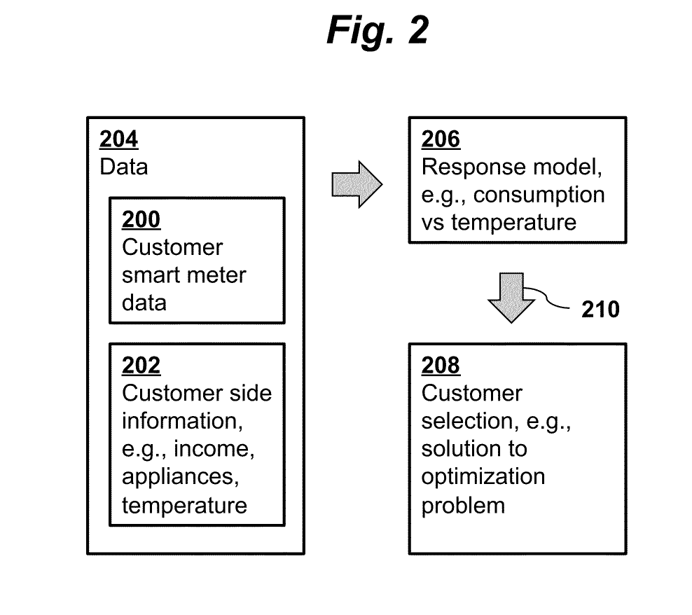

FIG. 2 is a schematic diagram illustrating an overall flow of a customer targeting process according to an embodiment of the invention. Customer data 204 includes smart meter data 200 and also may include customer side information such as customer income bracket, customer premises appliances, and outside temperature at the customer premises. In this embodiment, the objective is demand response (DR) program targeting. Data 204 is processed in 206 to generate response modeling from the raw smart meter data. Based on the information of customers' estimated responses 210, the customer selection process 208 is performed by solving an optimization problem.

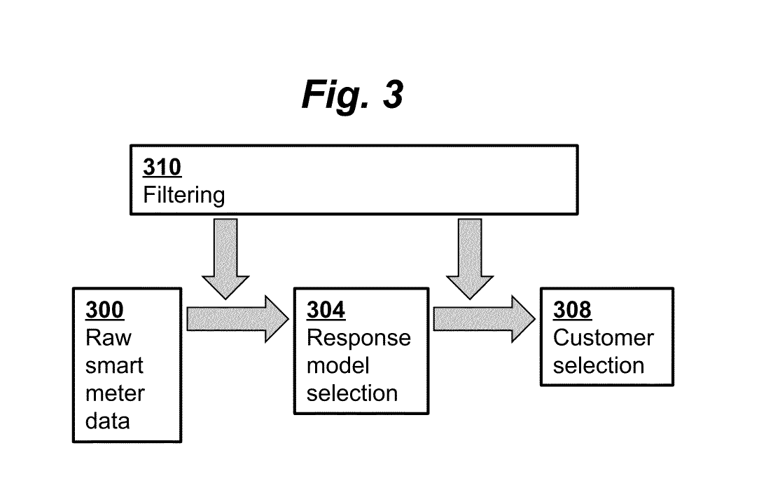

FIG. 3 illustrates additional advanced processing techniques for customer targeting according to an embodiment of the invention. In this embodiment for targeting customers for a certain DR program, a first stage is filtering out the candidate customers by a simple but reasonable and effective way (e.g., customers with very low consumption can be excluded as we cannot expect energy saving from them). The main idea is that we can reduce the number of candidate customers by combining multiple (segmentation) criteria and improve the scalability of the overall approach against the computation issue from large data set. The second stage is building a proper response model and estimate customers' response distributions depending on a given DR program. Additional filtering can be done on the result of response distribution. The third stage sets optimization problems for given purposes and select the customers by solving the optimization problems. A big benefit of this approach is that our targeting approach can be applied regardless of types of DR programs only if the response (expected energy saving of customers) can be expressed in probability distribution format with mean vector and covariance matrix. The practitioner can add more reasonable filters to reduce the number of candidates and make the detailed analysis to figure out the final candidates faster (e.g., customers with too low response may be excluded). Briefly, using the proper criteria as filters, the number of eligible households can be reduced quickly and a deep analysis requesting high computation cost can be done on a smaller number of candidates, which helps the approach is more scalable on large data sets.

As shown in FIG. 3, raw smart meter data 300 is used for response model selection 304 which provides information to customer selection process 308, as described above. It should be noted that the number of response models does not need to be one. From multiple models, we can select a proper model with appropriate verification process. Also, filtering processes 310 can be inserted prior to processing steps 304 and 308 to reduce the number of eligible targets so that the computation cost is reduced. Considering the type of an energy program or the easiness of targeting process, filtering stage can be omitted. A filtering process can eventually reduce the number of dimension in the optimization problem to select the proper customers and enable the solution to be obtained with greater computational efficiency.

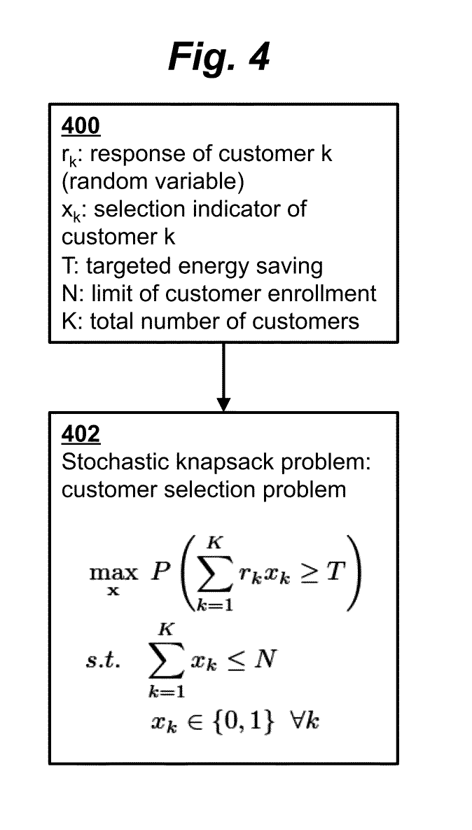

A targeting optimization program according to an embodiment of the invention is able to tradeoff between uncertainty and selection cost, with a goal to achieve a set demand response targeting goal with high probability during a DR event. FIG. 4 outlines the formulation of a stochastic knapsack problem to be solved for selecting a small number of proper customers from a large population, according to an embodiment of the invention. The variables of the problem definition are shown in box 400. The variable rₖ is a response of customer k corresponding to the energy saved during a DR event. It is a random variable whose distribution can be estimated by response model fitting. The distribution of rₖ is determined by fitting a response model corresponding to the type of DR and has a known joint probability distribution. The cost for customer k to participate in the program is cₖ. During planning, this cost represents the cost of marketing the program to a customer and rebates for a customer to purchase the resources to perform DR. The program operator has a budget C and desires an aggregate target response T (in kWh) from the program with the maximum reliability possible. DR availability is captured by the control variable T. DR reliability is naturally captured by the probability of the response exceeding the target energy saving T. The optimal DR program selection problem can then be stated as shown in 402, where xₖ∈{0,1} represents a selection indicator, i.e., whether a customer k is recruited or not. The utility desires to enroll up to N customers from a population of K individuals, aiming to achieve at least T kWh of energy savings with high probability. In this problem, T and N are design parameters decided by practitioners and both parameters are closely related with the strategy of targeting.

Note that, if cₖ is same for all customers, the budget constraint is the same as the constraint of limiting the number of participating customers by N, a limit of customer enrollment (i.e., Σcₖxₖ≦C [symbol] Σxₖ≦N if cₖ same, where the sums are over k from 1 to K). K is the total number of potential customers that can provide DR service. The problem can be stated as shown in 402, i.e.,

maxₓP(Σrₖxₖ≧T) s.t. Σxₖ≦N

where the sums are over k from 1 to K. The goal of the program is to maximize the likelihood of saving at least T kWh, given that we are limited to selecting at most N customers among K candidates. Maximizing the probability of achieving T is equivalent to reducing the risk of failing to meet the target during a DR event. Solving this stochastic knapsack problem (SKP) requires the probability distribution of the customer's response. This formulation generalizes to any linear program constraint.

The program maximizes the reliability of the DR program by recruiting customers within the program budget. The optimal reliability for budget C and target T is given by objective function value p*(C,T). The function captures the tradeoff between DR availability and DR reliability for a budget C. The function has some important properties that conform to our intuition about the tradeoff The objective function is monotonic decreasing in T so p*(C,T₁)≧p*(C,T₂) if T₁≧T₂. The budget determines the constraints so p*(C₁,T)≦p*(C₂,T) if C₁≧C₂.

The proposed optimization problem is a stochastic knapsack problem (SKP). SKPs are stochastic integer programs known to be NP-hard. Here we provide an efficient approximation algorithm that scales to K in millions of customers. The efficient algorithm is used then to compute the function p*(C,T).

An important additional assumption is that K is large and C is sufficiently large, so a significant number of customers are included. In that case, given a set of random variables for the response rₖ, the total group response is approximately Gaussian distributed.

The linear constraint in the optimization problem 402 does not need to be confined to the number of customer enrollment. Any linear constraint can be added. For example, we can add a cost constraint if the enrollment cost is different for each customer. Also, certain physical system constraints can be implemented as linear constraints, e.g., the number of customer enrollment in a sub-system is limited.

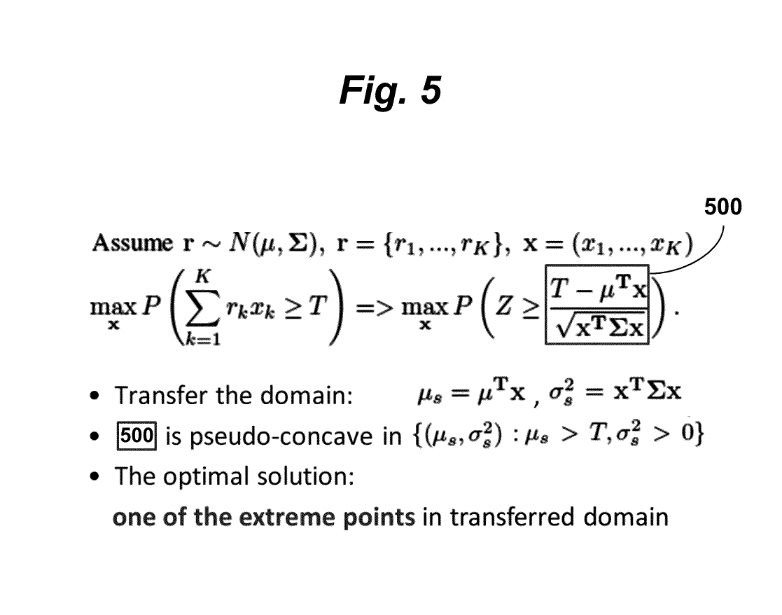

FIG. 5 illustrates the brief idea to find the optimal solution of the stochastic knapsack problem (SKP), according to an embodiment of the invention. The expression 500 is pseudo-concave over the convex set {(μₛ, σₛ²): μₛ>T, σₛ²>0}. Consequently, the set attains its minimum in an extreme point of the constraint set. The extreme points in a convex set can be found by linear programming. Specifically, the extreme points which are feasible to be the optimal solution can be obtained by solving

max_{μ}_{_{s,}}_{σ}_{ₛ}_{²}{λμ₂−(1−λ)σₛ²,(0≦λ≦1)}.

Alternatively, the SKP reduces to multiple knapsack problems (KP) on the assumption that all the σₖ²s are integers and all users are independent (i.e., the matrix Σ is diagonal). With these strong assumptions, this method is quite computationally efficient. An even more straightforward approach is to extend the concept of a greedy approximation algorithm utilized to solve specific instances of the knapsack problem. It utilizes the per customer risk-reward ratio μₖ/σₖ to sort and rank customers who are offering sufficient benefit. In the figure, x is the recruitment vector, N indicates a normal distribution, μ is a vector of individual response means μₖ and a covariance matrix with covariances Σⱼₖ between responses. In practice, if the number of customers selected is in the order of 50, the response distribution is very close to normal. The figure also shows how the objective function changes on the assumption that the responses are following a joint Gaussian distribution. We note it is very important that the optimal solution is one of the extreme points in the transferred domain. Finding the optimal combination of customers in original domain by constant times of sorting (or linear programming if there are other linear constraints beside the number of customer enrollment constraint), which makes the optimal extreme point in transferred domain a key point of our heuristic algorithm.

The method may also include minimizing the expected penalty when a DR event cannot achieve the targeted energy saving T, i.e.,

minₓqE(T−Σrₖxₖ)₊s.t. Σcₖxₖ<C)

where q is a penalty parameter with measure ($/kWh), and where the sums are over k from 1 to K. The interpretation is that we minimize the cost from utility side for buying additional energy when the energy saving cannot meet the target. This problem can be solved by exactly the same algorithm (used to solve the SKP problem in 402) after proving the objective is also quasi-concave in the concerned domain.

Additionally, the method may also include minimizing the cost for guaranteeing a certain level of probability, p, of achieving targeted energy saving for every DR event hour, i.e.,

minₓΣcₖxₖ<C s.t. P(Σr_{k,t}xₖ≦Tₜ)≧p, t∈h_{dr}

where h_{dr} means DR event hours, and we add one more subscript t to the targeted energy savings Tₜ, and where the sums are over k from 1 to K. The customers are selected who can save much for every hour in DR event duration. This problem can be solved as a SOCP (second order cone programming) after relaxing x vector as 0<xₖ<1.

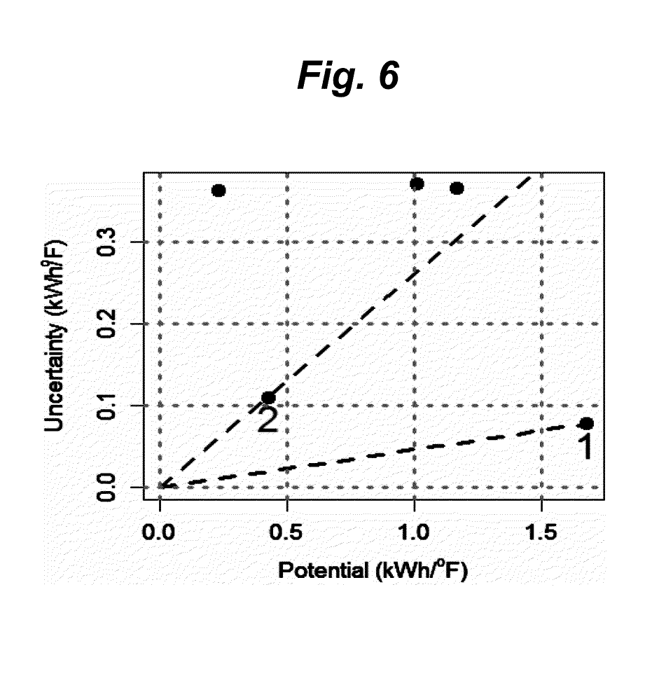

FIG. 6 shows an example of customer selection order in a simple greedy algorithm solving the SKP, according to an embodiment of the invention. It selects the customers just by the order of the ratio between potential and uncertainty. In the figure, the order is corresponding to the level of slope. That is the reason why the ‘1’ customer selected first as the slope is most gradual. The gradual greedy algorithm is a modified version of this simple greedy algorithm to satisfy 50% of probability when it is actually possible.

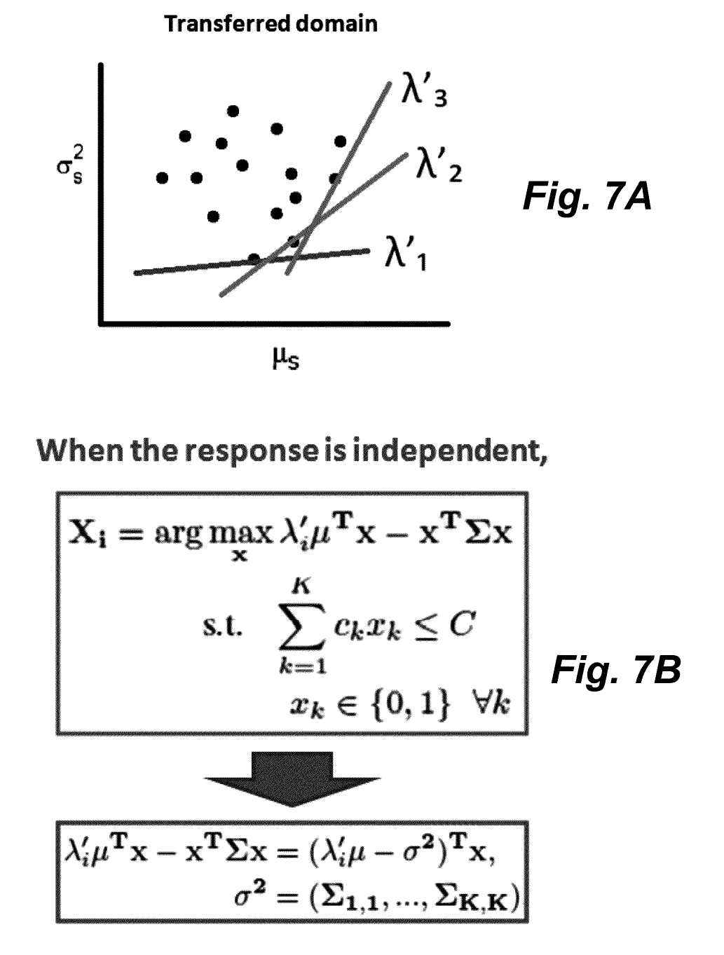

FIGS. 7A-B demonstrate two algorithms to solve the SKP, according to an embodiment of the invention. The optimal solution stays at one of extreme points in the transferred domain, μₛ=μ^{T}x, σₛ²=x^{T}Σx. Accordingly, the heuristic algorithm tries to find all extreme points and pick the best among them. FIG. 7A shows a scatter plot of points (μₛ, σₛ) in a σₛ² vs. μₛ graph. The algorithm approximately finds all extreme points by increasing the slope of lines (e.g., λ′₁, λ′₂, λ′₃ shown in FIG. 7A) with a equal angle. The technique finds the point on the slope with the minimum intercept.

The sub-problem, basically quadratic programming (QP), shown in FIG. 7B, corresponds to finding a combination of customers that makes the extreme point on a given slope. If we can assume the response is independent, this sub-problem changes to a linear programming (LP). If there is only one linear constraint about the number of customer enrollment, the LP becomes a simple sorting. Thus, with the assumption of having independent responses and the same targeting costs, our customer selection procedure guarantees a very close to optimal solution, with a computational complexity equivalent to that of sorting K entries in a vector. This is the most significant benefit of our heuristic algorithm, which enables customer selection even with a very large number of customers.

Depending on the targeting program, the response model can vary. Or, even in the same program targeting, there can be multiple response models. Thus, the key point of our targeting methodology is not how to set up the response model, but how efficiently we can select the small number of proper customers from a large population using the given information on the customers' response distribution.

Suppose the response modeling is done and the customers' estimated response distribution information is provided. Then, there can be several problem settings to select the proper customers depending on the needs of practitioners. For example, we can select the customers who can maximize the probability of achieving the targeted energy saving. Or, we can try to minimize the expected penalty when the targeted energy saving is not accomplished. Also, we can minimize the cost of achieving the targeted energy saving. The details of these three types of problem settings are described in one of the attached papers. All the problems started from the first problem setting, which is a stochastic knapsack problem (SKP). SKP is a combinatorial optimization problem which is well-known as a NP-hard problem. Thus, we developed an efficient novel heuristic with guaranteeing the approximate optimality.

Our targeting methodology is not confined to a specific DR program targeting. It can be utilized in recruiting the customers for any DR or EE (energy efficiency) program because our three-stage (filtering, response modeling and selection) targeting approach is flexible enough to cover other types of applications. For example, for any energy policy adoption or any targeting a certain type of people from a large population, if the objective function can be represented as one of our problem formats, basically our approach can work effectively. This makes sense because the response, reward or any type of reaction against a certain energy policy adoption or other program should be a probabilistic variable rather than a deterministic variable. Moreover, when we aggregate many variables (each variable represent a reaction of each entity in the program or policy) which are not totally dependent, it is natural and reasonable to assume following a Gaussian distribution. Additionally, the filtering process and response modeling can be changed properly depending on the given application.

The targeting methodology provided here has several important benefits:

1. the customer selection problem settings (which are based on the stochastic knapsack problem) are general.

2. the heuristic algorithm to solve the SKP is very efficient and scalable on a larger population or larger data sets.

3. by the filtering process (if possible), it makes the customer selection problem solving faster and enables analyzing even more in detail on small number of eligible customers.

Preferred embodiments of the invention make use of a variety of machine learning algorithms. For example, we fit one of the consumption models using EM (expectation maximization) style process. Moreover, we developed an efficient heuristic to solve a stochastic knapsack problem (SKP) with approximate optimality proof, which requires only constant times of solving a linear or quadratic programming problem. In our approach, if we can assume the customers are independent, the SKP becomes only constant times of sorting certain scores among all customers. For a modified problem (the problem minimizing the penalty in the attached paper), we proved its quasi-concavity and it can be also solved in the same heuristic we developed. As a byproduct of quasi-concavity proof, we obtained a tighter lower bound for the complementary cumulative distribution function for some range in a standard normal random variable.

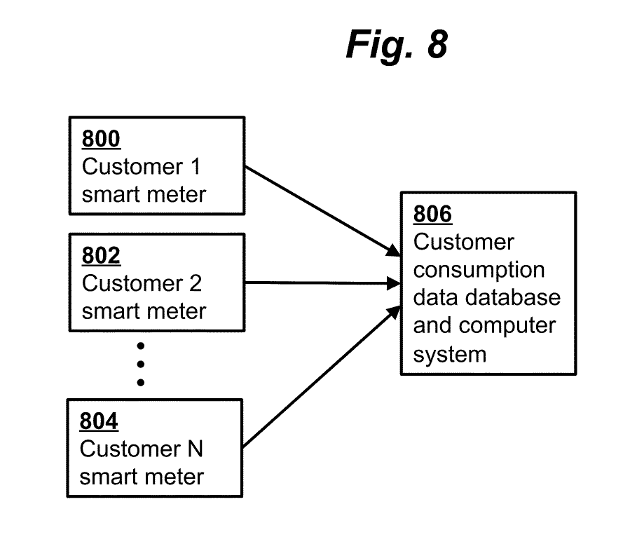

FIG. 8 is a schematic overview of a system which may be used to implement the techniques of the present invention. Customer smart meter devices 600, 602, through 604 are installed at utility customer locations to produce time-series utility resource consumption data, preferably at high resolution, i.e., measurements at least once per hour, more preferably at least once per 15 minutes. The time series data, which includes customer identifier, resource use, and timestamp, are transmitted over a wired or wireless data connection to a database and computer system 606 which collects, stores, and analyzes the customer consumption data. Computer system 606 may comprise one or several computers to run all the encoding process, feature extraction and segmentation computation, and targeting, interacting with a database server. Preferably, to estimate each customer's response distribution from large size of consumption data and solve multiple high dimensional linear programming (or quadratic programming) problems, two or more computing resources are used. To enhance the data transfer speed (incoming raw data or data exchange between different machines) and the computation speed, any advanced hardware specification can be implemented. As illustrated in FIG. 1, the system may also include communication to and/or with utility customers 100, and standard communications hardware to implement such techniques.

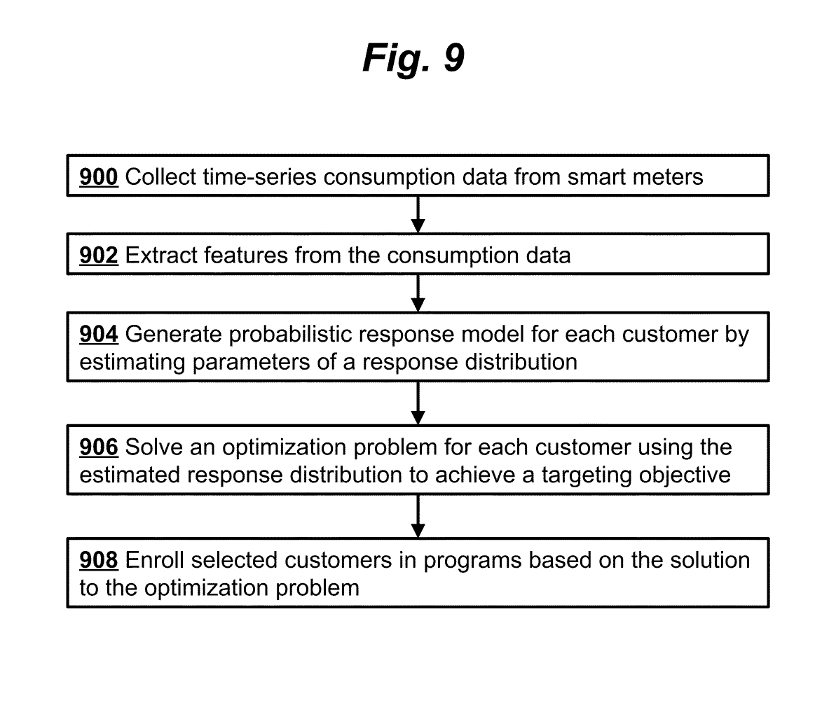

FIG. 9 outlines the main steps performed by the system according to a preferred embodiment. In step 900 the raw time-series consumption data is collected from the smart meters. This step may also include pre-processing the raw time-series consumption data by cleansing and imputation.

In step 902 features are extracted from the data, and in step 904, depending on a selected DR program, probabilistic response model(s) are generated for each customer based on the extracted features. The probabilistic response model reflects the relationship between feature and program performance. The response model gives a predicted output for a customer conditional on external factors, customer dependent factors, etc. For example, feature can be temperature sensitivity, and program performance is the number of kWh a customer generates in a program. The probabilistic response model is then utilized for targeting. The response model gives a predicted output for a customer conditional on external factors, customer dependent factors, etc. The customer response model specification depends on the design of the demand response program. Consider a Global Temperature Adjustment (GTA) program for HVAC (air conditioning) systems. Such a program increases the temperature set point of the air conditioner for each customer by a fixed amount to reduce cooling power consumption. Selecting customers with high energy saving potential during a DR event day and hour requires an accurate model to estimate the total energy consumed at each set point level. For example, The power consumption of a customer k at time t on day d, is modeled as a function of outside temperature, HVAC temperature break-point, cooling sensitivity, heating sensitivity, and base load. If HVAC consumption is independently metered, a simple model can be built utilizing the observed consumption, external temperature and the utilized set point. In general, though, only total home consumption and external temperature are observed.

Model learning is performed in two steps. Minimization of residual sum of squares (RSS) is utilized to learn the parameters of the model and the distribution of the error from the observed data. An F-test is utilized to prevent over-fitting. The overall computation needed to fit the consumption model is to solve (at most) 20 linear regression models: one for each potential value of the breakpoint (at most 19 for the integer breakpoints between 68° F. and 86° F., which is typical) and one for the basic model (the case when cooling sensitivity is the same with heating sensitivity).

The targeting model selection procedure can include an optional step of filtering target choices according to their load profile characteristics.

In some embodiments, the targeting incorporates a discrete choice model or other choice model options that predict consumer propensity to enroll. This can be directly treated in the same manner as with reliability.

Once the model is generated and selected, it is used to estimate the parameters of a response distribution.

In step 906, based on the estimated response distribution, targeting is performed by solving an optimization problem (or several) depending on the targeting objective. For example, the targeting maximizes the probability of achieving the target, constrained on a budget cost (number of users, dollars, etc.), and other additional constraints such as variance of response, conditional value at risk and value of risk of response.

The targeting method includes for each customer a reliability constraint to capture the behavioral compliance to a demand response signal. The compliance is given by a compliance response model and it is a function of consumer characteristics, local environmental characteristics, time of day and other factors. The reliability constraint can be directly included in the objective function of the optimization. If reliability for customer i is γᵢ and response is rᵢ, a new compliance adjusted response \tilde{r}ᵢ=γᵢrᵢ, is defined and can be used in the regular targeting algorithm.

In some embodiments, the targeting method is separately performed periodically (e.g., each hour), or performed for multiple hours jointly (providing a best enrollment for a target shape).

Some embodiments may include computing a target response curve of desired response level (corresponding to DR availability) vs. required number of consumers (corresponding to DR cost) with guaranteeing a certain DR reliability. If a practitioner has this curve, he or she can decide a sweet spot in the curve as the DR operation point considering the constraints (e.g., budget, target energy saving).

In step 908, enroll the customers in the programs, perhaps involving communicating first with the selected customers to encourage them to enroll in a certain DR program, and enrolling them based on their response.

In some embodiments, compliance factors may be integrated into the customer selection optimization problems on the assumption that each customer's compliance variable is independent from his response variable and is provided in eligible types:

1. A fixed constant, a kind of discount rate.

2. A Bernoulli random variable with a success probability.

A customer's compliance may be integrated into any customer selection problem by changing the response variable from rₖ to aₖrₖ. Moreover, we can solve the problems on the assumption that the sum of responses is following a Gaussian distribution, with different Gaussian distribution parameters.

1. A method implemented by a computer for enrolling utility customers in utility demand response or energy efficiency programs based on time-series consumption data, the method comprising:
collecting by the computer from smart meter sensors time-series utility consumption data from individual utility customers;
extracting by the computer features from the consumption data;
generating a probabilistic response model for each customer representing a relationship between the extracted features and customer program performance; wherein generating a probabilistic response model comprises estimating parameters of a response distribution;
solving an optimization problem for each customer using the estimated response distribution to achieve a targeting objective;
enrolling selected customers in programs based on the solution to the optimization problem.

2. The method of claim 1 further comprising solving the optimization problem periodically.

3. The method of claim 1 wherein the optimization problem includes a reliability constraint that captures behavioral compliance to a demand response signal, wherein the behavioral compliance is represented by a compliance response model dependent upon consumer characteristics, local environmental characteristics, and time of day.

4. The method of claim 1 further comprising selecting a probabilistic response targeting model from among multiple probabilistic response targeting models.

5. The method of claim 1 further comprising communicating to the selected customers the programs.
